(19) United States
(12) Patent Application Publication
(10) Pub. No.: US 2025/0356126 A1
(43) Pub. Date: Nov. 20, 2025

(54) LOGITS-BASED DETECTOR WITHOUT LOGITS FROM BLACK-BOX LLMS

(71) Applicant: NEC Laboratories America, Inc., Princeton, NJ (US)

(72) Inventors: Wei Cheng, Princeton Junction, NJ (US); Haifeng Chen, West Windsor, NJ (US); Dongkuan Xu, State College, PA (US); Xianjun Yang, Santa Barbara, CA (US)

(21) Appl. No.: 19/194,706

(22) Filed: Apr. 30, 2025

Related U.S. Application Data
(60) Provisional application No. 63/647,106, filed on May 14, 2024.
(60) Provisional application No. 63/649,569, filed on May 20, 2024.

(51) Int. Cl. G06F 40/284; G06F 40/205; G06F 40/40

(52) U.S. Cl. CPC G06F 40/284; G06F 40/205; G06F 40/40

(57) ABSTRACT

Systems and methods for detecting Large Language Model (LLM) generated text are provided. The systems and methods include sampling a text passage to generate alternative samples conditioned on the text passage based on a next token prediction in a surrogate LLM model and scoring a likelihood that the test passage sample is generated by an LLM model. The scoring includes a conditional probability which quantifies a distribution gap of a log of logits from the surrogate LLM model. The systems and methods further include comparing the scored text passage with a sample text generated in the surrogate LLM model trained to imitate a target LLM model. The comparison includes transforming the scores into a scaled representation and normalizing the scores.

### RELATED APPLICATION INFORMATION

This application claims priority to U.S. Provisional Patent Application 63/647,106, filed on May 14, 2024, and U.S. Provisional Patent Application 63/649,569, filed on May 20, 2024, incorporated herein by reference in their entirety.

### BACKGROUND

### Technical Field

Embodiments of the present invention relate to detecting the origins of text and more particularly whether text originates from a human or a language model.

### Description of the Related Art

Methods for detecting text generated by Large Language Models (LLMs) are broadly categorized into watermarking, training-based classifiers, and zero-shot detectors. Watermarking methods discreetly embed identifiable markers within the text output, striving to retain the model's linguistic integrity. However, this tactic is implementable solely by the model provider. Training based classifiers, while effective, are costly and often lack the agility to adapt to new domains or model updates.

Most zero-shot detectors depend on analyzing model output logits for detection. Some operate on probability divergence based upon principles of perturbation theory, while others harness reporting-based probability divergence, and even further, some build on variations in conditional probability distributions. In scenarios using the scrutiny of black-box models, these strategies commonly leverage a surrogate model to approximate the behavior of the target model.

However, this approach has drawbacks. Detection efficacy is linked to a tailored surrogate model, with different surrogate models often necessary for accurate detection across various proprietary Large Language Models (LLMs) and LLM updates rendering past surrogates obsolete against new versions.

### SUMMARY

According to embodiments of the present invention, a method is provided for detecting Large Language Model (LLM) generated text. The method includes sampling a text passage to generate alternative samples conditioned on the text passage based on a next token prediction in at least one surrogate LLM model and scoring a likelihood that each test passage sample is generated by an LLM model. The scoring includes a conditional probability which quantifies a distribution gap of a log of logits from the at least one surrogate LLM model. The method also includes comparing the scored text passage with a sample text generated in the at least one surrogate LLM model trained to imitate a target LLM model. The comparison includes transforming the scores into a scaled representation and normalizing the scores.

According to another embodiment of the present invention, a system is provided for detecting LLM generated text. The system includes a processor and a memory storing computer-readable instructions that, when executed by the processor, cause the system to sample a text passage to generate alternative samples conditioned on the text passage based on a next token prediction in at least one surrogate LLM model and score a likelihood that each test passage sample is generated by an LLM model. The score includes a conditional probability which quantifies a distribution gap of a log of logits from the at least one surrogate LLM model. The memory also causes the processor to compare the scored text passage with a sample text generated in the at least one surrogate LLM model trained to imitate a target LLM model. The comparison transforms the scores into a scaled representation and normalizes the scores.

According to yet another embodiment of the present invention, a computer program product is provided for detecting LLM generated text. The product includes a non-transitory computer-readable storage medium containing computer program code, the computer program code when executed by one or more processors causes the one or more processors to perform operations. The computer program code including instructions to sample a text passage to generate alternative samples conditioned on the text passage based on a next token prediction in at least one surrogate LLM model and score a likelihood that each test passage sample is generated by an LLM model. The score includes a conditional probability which quantifies a distribution gap of a log of logits from the at least one surrogate LLM model. The computer program code also compares the scored text passage with a sample text generated in the at least one surrogate LLM model trained to imitate a target LLM model. The comparison includes transforming the scores into a scaled representation and normalize the scores.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for detecting LLM model generated text, in accordance with an embodiment of the present invention;

FIG. 2 is a block diagram illustrating a system for detecting LLM generated text with a logit-based detection technique, in accordance with an embodiment of the present invention;

FIG. 3 is a graph illustrating probability distribution curvature of several surrogate LLM models, in accordance with an embodiment of the present invention;

FIGS. 4 and 5 are a flow diagram illustrating a method for fine-tuning a surrogate LLM model, in accordance with an embodiment of the present invention;

FIG. 6 is a flow diagram illustrating a detailed method for detecting LLM generated text, in accordance with an embodiment of the present invention; and

FIG. 7 is a block diagram illustrating a computer implemented system for detecting LLM generated text, in accordance with an embodiment of the present invention.

### DETAILED DESCRIPTION OF PREFERRED EMBODIMENTS

The advent of Large Language Models (LLMs) has revolutionized text generation, producing outputs that mimic human writing. This blurs the lines between machine- and human-written text and presents new challenges in distinguishing one from the other, a task that is further complicated by the frequent updates and closed nature of many proprietary LLMs.

LLMs such as ChatGPT®, GPT-4®, Llama®, and Claude-3 have impacted both industrial and academic domains, reshaping productivity across various sectors including news reporting, story writing, and academic research. Nevertheless, misuse of LLMs also raises concerns, particularly regarding the dissemination of fake news, the proliferation of malicious product reviews, and plagiarism. Instances of artificial intelligence-(AI) synthesized scientific abstracts deluding scientists have raised doubts about the reliability of scientific discourse. Accurate and reliable machine-generated text detection techniques can be useful to address these issues.

Traditional logits-based LLM detection methods leverage surrogate models for identifying LLM-generated content when logits are unavailable from black-box LLMs. However, these methods have difficulty with the misalignment between the probability curvature distributions of the surrogate model and the (often-undisclosed) target models, leading to performance degradation, particularly when new, closed-source models are introduced. Furthermore, while current methodologies are generally effective when the source model is identified, current detection models falter in scenarios where the model version remains unknown, or the test set comprises outputs from various source models.

To address these limitations, a distribution-aligned LLM detection framework is provided. Embodiments of the present invention include a framework that redefines the state-of-the-art (SOTA) performance in black-box text detection even without logits from source LLM. A logit is link function that correlates probabilities ranging between 0 and 1 to real numbers, which can then be expressed as linear relationships. The logit function can be the inverse of a logistic sigmoid function and can model the odds of a binary outcome. The framework can be implemented for either a single source LLM or a variety of source LLMs. Embodiments of the present invention align the surrogate model's probability curvature distribution with that of an unknown probability curvature distribution of a target (source) LLM. Minimizing the gap between these curvatures ensures enhanced detection capability and resilience against rapid LLM model iterations with minimal training investment. In other words, the framework can adapt to target LLM changes quickly and easily to make the model most effective.

By leveraging a corpus of samples from advanced LLM models, embodiments of the present invention can fine-tune surrogate models to synchronize known surrogate LLM model distributions with unknown source LLM model distributions. The target LLM models can include ChatGPT®, GPT-4®, Claude-3, etc., which may have publicly accessible outputs.

Some embodiments of the present invention use zero-shot detectors that apply the intrinsic differences between text written by machines and humans, offering the advantage of being generally training-free. Previous text generation detectors consider white-box LLMs but fail to when detecting text for black-box LLMs. Embodiments of the present invention can detect generated text from black-box LLMs.

White-box LLMs display the system's internal workings, structure, and logic. A user can inspect how the system operates, understand the reasoning behind the system's predictions or outputs, and can explain the decisions made by the system. Contrasting white-box LLMs, are black-box LLMs that allow the user to view the input and the output, but not the process used to derive the output from the input. This makes third-party use of black box LLMs more difficult than third-party use of white box LLMs.

Zero-shot is a form of machine learning which includes training a machine learning algorithm to recognize objects or concepts without having seen any examples of those objects or concepts previously. Alternatives to zero-shot learning include few-shot and one-shot which training on a few examples and one example, respectively.

Embodiments of the present invention apply a probability curvature distribution gap between a given surrogate model and a target (source) model to identify the likelihood of a target LLM produced response. The surrogate model is a less complex, open-source model that approximates a more technically nuanced, higher-order target model. The surrogate model can be fine-tuned to map input data to outputs when the actual relationship between the two models is unknown or computationally expensive to evaluate, making surrogate LLM models useful for scenarios including black-box target LLMs. The target LLM model is the original, technically complex model the surrogate model is replicating.

Embodiments of the present invention can train a distribution-aligned surrogate model to approach the distribution of the target model so that the surrogate model can evaluate and determine when a given text originated from the target LLM model. The training data for the surrogate model is generated by prompting the target LLM model and recording the prompt and answer (response). Embodiments of the present invention can further collect a set of small-sized training data generated by the target LLM model from the publicly shared outputs and finetune the surrogate model to align the distribution of the target source model.

The text generation process can include the following components. (1) a sampling model used to generate alternative samples conditioned on a given input passage, and based on the next token prediction; (2) a conditional score, which can be obtained through a forward pass of a scoring model, using the given input passage as the input; and (3) conditional probabilities of the given text passage compared with the sample to calculate the probability curvature distribution.

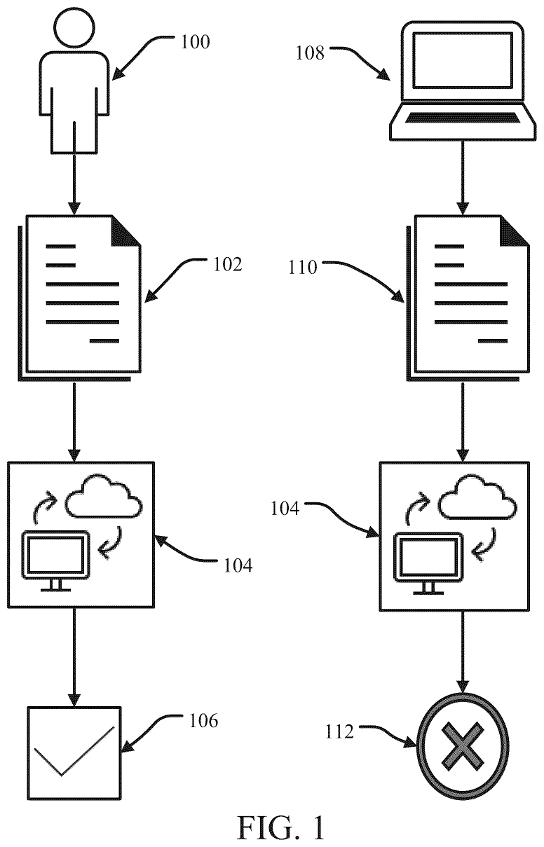

Referring now in detail to the figures in which like numerals represent a same or similar elements and initially to FIG. 1, a block diagram of an example system of the framework is illustrated. In accordance with an embodiment of the present invention, user 100 can generate user text 102, which can include a single letter, a single character, or word. Alternatively, user text 102 can be longer, including essays, speeches, paragraphs, resumes, plays, books, or other texts.

User text 102 can then be input into a detection algorithm 104, which applies a detection framework to determine whether the text is generated by user 100 or an LLM 108.

Detection algorithm 104 can also evaluate LLM 108 for LLM text 110 in detection algorithm 104. LLM text 110 can be the same types of text as user text 102. The output of detection algorithm 104 can either be an evaluation that the text is human generated 106 or LLM generated 112. User text 102 can be parsed into groups of predetermined size if the original text size is too large. For example, every 100 words can be a group which the framework evaluates the origins of. Other embodiments of the present invention can parse text into paragraphs, sentences, sections, chapters, etc.

Detection algorithm 104 can be used in plagiarism software and research or assignment submission software. For example, detection algorithm 104 can be employed in an academic setting to ensure assignments that are required to be completed by user 100 (e.g., without LLM text 110) do not include LLM 108 generated text. Alternatively, detection algorithm 104 can be used to verify that LLM 108 did not generate text in submission of documents which have restricted the use of LLM 108 generated text, which is present in some industries, e.g., court filings. The framework can detect the impermissible use of LLM 108 generated text such as in professional document filings, e.g., medical or legal records, or in academia without permission. Other embodiments of the present invention can limit LLM 108 generated text use in competitions or academic research paper submissions. In even further embodiments of the present invention, the framework can be added to other systems such as word processing software or act as a stand-alone product. As an add-on, the framework can compare the entire document for LLM 108 generated text or user selected portions.

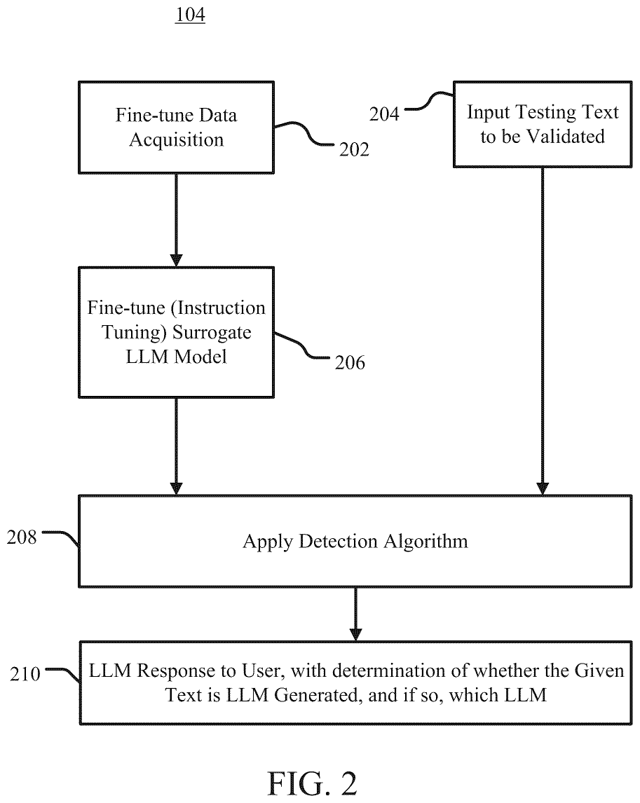

Now referring to FIG. 2, a block diagram of the framework is illustrated in accordance with an embodiment of the present invention. Detection algorithm 104 can initially acquire fine-tune data 202, which is data for training detection algorithm 104. Information can be acquired from both humans and machines. Acquiring fine-tune data 202 can use publicly available datasets or use information collected for the purpose of LLM text 110 (FIG. 1) detection. Fine-tune data 202 can be responses to prompts. The prompts can be on a variety of topics which can give the detection algorithm 104 more versatility in different types and topics of text. The prompts and the responses can be cataloged in pairs. Detection algorithm 104 can advantageously train on new datasets as they are released, which can ensure the system is trained on the most recent versions and newest models without implementing an entirely new framework.

Adapting to new trends in language, speech, diction, syntax, etc., can aid detection algorithm 104. For example, the colloquialisms “epic” and “basic” originate from different generations of people while in their youth (millennials used “epic” whereas generation Z used “basic”). Detection algorithm 104 can remain lockstep or close to lockstep with these trends through updating and training continuously when new datasets are available. Similarly, slogans and phrases such as “I'm just here so I don't get fined” can become popular almost instantaneously through social media, tending to create a temporary gap between human language and artificial intelligence knowledge that continuous training can minimize. Minimizing these gaps can improve detection algorithm 104 efficacy.

In embodiments of the present invention, the collected dataset can be defined as S={(Pᵢ, Xᵢ)}ᵢ₌₁^{N} for the distribution of the surrogate model fₛᵤᵣ to align with the target model fₜₐᵣ. S can include sample text generated in at least one surrogate LLM model 206. The dataset can be referred to as an alignment dataset. N refers to the number of collected text samples, Pᵢ is the text for prompting, and Xᵢ is the corpus generated by fₜₐᵣ (e.g., the responses to the prompts). The collected data can be from the same model type as the target model. For example, if the test data is generated by GPT-4-0613, then the texts in the dataset S can also be generated by GPT-4-0613.

The detection algorithm 104 improves the scoring step of other logit-based methods, such as DetectGPT® by incorporating the surrogate LLM model 206 to detect LLM text 110 (FIG. 1). DetectGPT® utilizes the source model (e.g. LLM 108) to score (which is applicable white-box settings but not black box settings) the input. Other algorithms, such as Fast-DetectGPT, replace the perturbations-based sampling method with conditional probability sampling. The scoring on these conditional probability sampling models is performed by an open-source surrogate model. The conditional probability (p) in these instances can be defined as

$$p ( \hat{x} \vert x ) = {\prod }_{l} {s}_{θ} ( \hat{x} \vert {x}_{< l} )$$

where l is a position of the word in the text, \hat{x} is a sample generated by the sampling model and x is the input passage and s_{θ} is the open-source model.

Detection algorithm 104 can fine-tune the surrogate LLM model 206 which receives the acquired data from fine-tune data 202 for training. Fine-tuning surrogate LLM model 206 can incorporate instruction tuning. The data fed into surrogate LLM model 206 can be paired data (e.g., a question and an answer). Each LLM 108 (FIG. 1) has a separate surrogate LLM model 206. In other words, surrogate LLM model 206 is for a given LLM 108 (FIG. 1) and an additional surrogate LLM model 206 can be trained for the framework to have the capability to identify a corresponding additional LLM 108 (FIG. 1).

Instruction tuning is a form of transfer learning that teaches the surrogate model using “real-world,” current examples of text generated by black-box LLMs. The instruction tuning updates the surrogate model's understanding of stylistic and linguistic patterns used by these models. Instruction tuning uses a labeled dataset of instructional prompts and corresponding outputs. Instruction tuning improves model performance by following instructions in general, thereby helping adapt pre-trained models for practical uses such as employment in new LLMs 108 (FIG. 1). In an embodiment, fine-tune data 202 can fine-tune surrogate LLM model 206 using instruction tuning by inputting text into the target model (e.g. LLM 108) and receiving a response in the form of LLM text 110 (FIG. 1). These input texts' and LLM text 110 can be cataloged together. Then, the input text can be input (e.g. tested/fine-tuned) in surrogate LLM model 206. Surrogate LLM model 206 be fine-tuned until the LLM text 110 (FIG. 1) output to a given input is the same (or reaches a similarity threshold) as the response from LLM 108 (FIG. 1).

Other embodiments of the present invention include prompt engineering, reinforcement learning from human feedback, reinforcement learning from artificial intelligence feedback, in-context learning (e.g., few-shot, one-shot, zero-shot), adapters like Low Rank Adaption (LoRA), Quantized LoRA (QLoRA), embedding-based retrieval like Retrieval-augmented generation (RAG), custom decoding and filtering, post-hoc re-ranking or output selection, and chain-of-thought, etc.

The instruction tuning is dynamic and evolves with LLM innovation, meaning as LLMs change and improve accuracy, the training can reflect these changes. Rather than being static with a dataset, instruction tuning allows for changes in the field of black-box LLM innovation to be implemented in the framework. This continuous tuning can be implemented in real time or near real time.

Applying the text detection algorithm 208 includes receiving the surrogate LLM model 206 as an input to determine a given text for the source of origin. Also received within text detection algorithm 208 is testing text passage 204. Testing text passage 204 is text being evaluated for the origin of the text which can be either human generated or LLM 108 (FIG. 1) generated or a mixture of both. Applying text detection algorithm 208 can determine whether a human or LLM 108 (FIG. 1) had generated the text by scoring and comparing fine-tune data 202 and text passage 204. The text origin is determined through statistical and machine learning techniques that adjust the surrogate LLM model 206 parameters to reduce the probability curvature distribution gap. The techniques used can include applying perplexity, log of logits, cross-entropy, etc. The probability curvature distribution gap which is reduced can be an entropy gap.

The probability curvature distribution refers to the overlap of detection algorithm 104 determinations of an event in comparison to what the truth is from LLM 108 (FIG. 1). In some embodiments of the present invention the gap may be referring to probability distribution (density) functions. Embodiments of the present invention prefer maximum overlap of the functions which can indicate the highest likelihood of the prediction being correct. In other words, the more similar the surrogate model and the target model functions are, the more likely the surrogate is accurately predicting the origin of the text.

The output of text detection algorithm 208 is response 210. The text detection algorithm 208 can identify a likelihood, in the form of a score, of the origin as either being human or LLM 108 (FIG. 1) generated text. Detection algorithm 104 can also provide which LLM 108 (FIG. 1) had generated the text if the origin is determined to be from LLM 108 (FIG. 1). The score can quantify the distribution gap of the log of logits. The score can provide a final determination of user 100 and LLM 108 (FIG. 1) generated text or can be compared to other scores.

Text detection algorithm 208 can be integrated with a third-party detection algorithm or can be proprietary. Examples of third-party detection algorithms include e.g., FastDetectGPT and DNA-GPT.

Embodiments of the present invention can construct the LoRA of surrogate model fₛᵤᵣ for faster and more stable fine-tuning. The LoRA model f_{sur+θ} is trained with a collected dataset,

$$S = {\{ ( {P}_{i} , {X}_{i} ) \}}_{i = 1}^{{K}_{1}}$$

where K₁ is the number of samples, while the parameter of the original surrogate model fₛᵤᵣ is static, P is the prompt, X is the text, and y is the parsed text and prompt according to y=[Pᵢ, Xᵢ]. The model f_{sur+θ} utilizes a tokenized input (e.g., text input passage), x, and is trained in a self-supervised learning manner. The training objective of the fine-tuning can include:

$${max}_{Θ} {\sum }_{y = [ P , X ] ∈ S} {\sum }_{l = l ( P ) + 1}^{l ( P ) + l ( X )} log p ( {y}_{l} \vert y < l ; sur + Θ )$$

where l(X) denotes the length of a passage X, where l(P) denotes the length of a prompt P, and yₗ is a next token to be predicted. In order to disable the influence of the prompt, embodiments of the present invention follow instruction tuning to mask the gradient of the prompt. Following the finetuning, the distribution-aligned surrogate model can be utilized to compute the logits for downstream decisions. LoRA can reduce the number of computations by holding some parameters frozen while others are iterated.

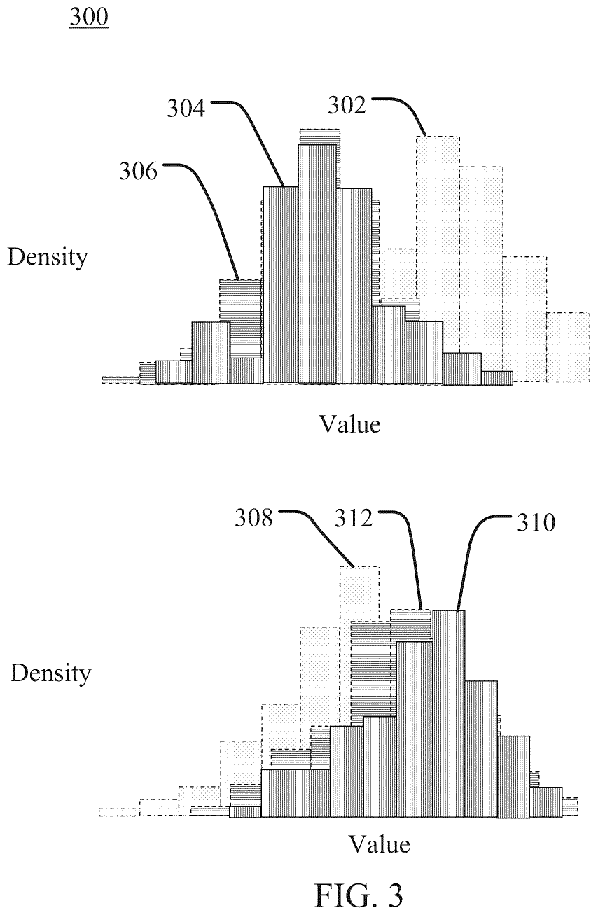

Now referring to FIG. 3, a probability curvature distribution graph is illustrated. Probability curvature distribution graph 300 shows the probability that a given text is generated by a given source when the text is human generated and LLM 108 (FIG. 1) generated. In other words, probability curvature distribution graph 300 depicts the likelihood of the detection framework accurately predicting whether a text is AI generated, or human generated in both possible situations (when the text passage 204 (FIG. 2) is LLM 108 (FIG. 1) generated and when the text passage is human generated).

An LLM distribution curve can be demonstrated by actual probability distribution 304 (solid outline, vertical stripe pattern) of the target model being analyzed when the text is human generated. Matching actual probability distribution 304 as closely as possible minimizes the distribution gap and optimizes the model. Non-optimized distribution curve 302 (dash-dot outline, dotted pattern) depicts a distribution curve of a surrogate model not employing embodiments of the present invention to be optimized with updates to a given model (e.g., non-optimized distribution curve 302 does not have instruction tuning to continuously update the model with new data). In an embodiment, non-optimized distribution curve 302 can be skewed to the right. This can indicate that non-optimized distribution curve 302 determined that there is a higher likelihood than not that a given text passage 204 (FIG. 2) is LLM 108 (FIG. 1) generated. As LLMs become more common place and LLM 108 (FIG. 1) generated text becomes more human-like non-optimized distribution curve 302 can be rendered outdated, obsolete, and/or unreliable.

In place of non-optimized distribution curve 302, optimized distribution curve 306 (dash outline, horizontal stripe pattern) can more closely align with actual probability distribution 304 and can more accurately predict the origin of a given text. The distribution gap between actual probability distribution 304 and optimized distribution curve 306 can be smaller than that between actual probability distribution 304 and non-optimized distribution curve 302. Optimized distribution curve 306 depicts the distribution curve of the surrogate model implementing embodiments of the present invention. Actual probability distribution 304 and optimized distribution curve 306 have a small probability distribution gap indicating the likelihood that embodiments of the present invention would perform well at indicating when LLM 108 (FIG. 1) generated text is human generated. The peaks are much closer than the peak for non-optimized distribution curve 302 is to actual probability distribution 304.

FIG. 3 also depicts an actual probability distribution 310 (solid outline, vertical stripe pattern) of the target model being analyzed when the text is LLM 108 (FIG. 1) generated. Non-optimized distribution curve 308 (dash-dot outline, dotted pattern) is similar to non-optimized distribution curve 302 and optimized distribution curve 312 (dash outline, horizontal stripe pattern) is similar to optimized distribution curve 306. When the text is LLM 108 (FIG. 1) generated, the optimized distribution curve 312 has a smaller probability distribution gap with actual probability distribution 310 than non-optimized distribution curve 308 has with actual probability distribution 310.

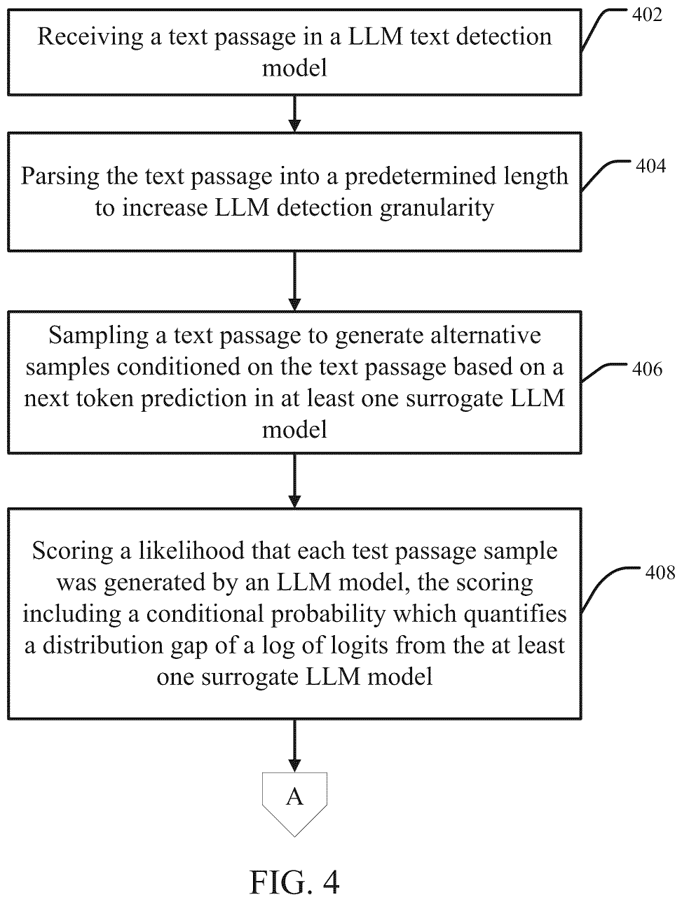

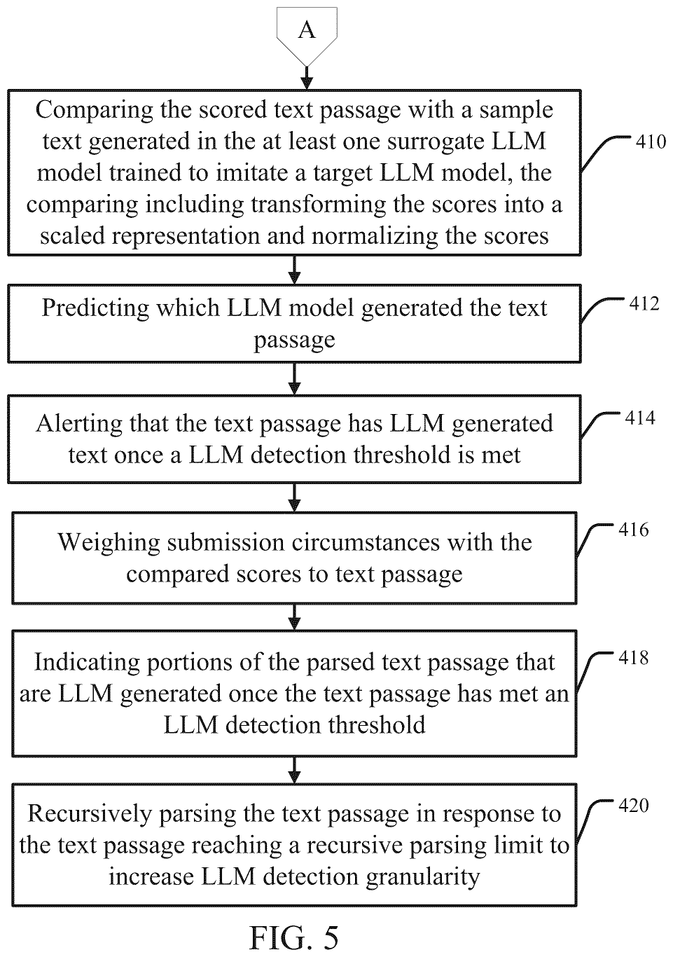

Now referring to FIGS. 4 and 5, a flow chart of the framework in accordance with an embodiment of the present invention is depicted. In block 402, text is received in LLM text detection model. The text received can be a text passage. The text can either be generated by a user or by an LLM. The text can be as short as a single character or word, or lengthy, e.g., a screenplay. In block 404, the text passage 204 (FIG. 2) can be parsed into a set of passages, each passage being a length suitable for text origination detection. This length can be predetermined. The parsing can increase LLM text detection granularity of the algorithm when detecting for LLM 108 (FIG. 1) generated text. The increased granularity allows the algorithm to more accurately predict LLM 108 (FIG. 1) text detection and reduces both false positive and false negative results.

In block 406, fine-tune data is sampled from each text passage 204 (FIG. 2) to generate alternative samples conditioned on the text passage 204 (FIG. 2) based on a next token prediction in the surrogate LLM model 206 (FIG. 2). The samples are generated in the surrogate LLM model 206 (FIG. 2) which is trained to imitate a target LLM 108 (FIG. 1) model. In block 408, the text passages are scored for a likelihood that each test passage sample is generated by an LLM 108 (FIG. 1), the scoring includes a conditional probability which quantifies a distribution gap of a log of logits from the at least one surrogate LLM model 206 (FIG. 2).

In block 410, the scored test passage 204 (FIG. 2) and the sample text generated in the at least one surrogate LLM model 206 (FIG. 2) are compared. The comparison provides the algorithm an understanding of the similarity of the text passage 204 (FIG. 2) with data from the surrogate LLM model 206 (FIG. 2) and can include transforming the scores into a scaled representation and normalizing the scores. In block 412, the algorithm predicts which LLM 108 (FIG. 1) generated the text passage. In block 412, the algorithm can also provide a prompt that is likely the input, or similar to the prompt, into the LLM 108 (FIG. 1) to generate the given text passage.

In some embodiments of the present invention, the algorithm include block 414 which can send a notification or alert to a third-party that LLM 108 (FIG. 1) generated text passage (FIG. 2) is detected. The algorithm can also include in the alert, the confidence the algorithm has in the prediction, in the form of a confidence score. The confidence score can be defined in some embodiments of the present invention as the confidence the LLM 108 (FIG. 1) has generated the given text passage 204 (FIG. 2). In other words, a lower score indicates more confidence a human generated the text passage 204 (FIG. 2) and a higher score indicates more confidence LLM 108 (FIG. 1) generated text passage 204. Alternatively, the algorithm can warn the party submitting the text passage 204 (FIG. 2) of the indication that LLM 108 (FIG. 1) generated text passage is detected. The algorithm can be set to have a certain LLM detection threshold which can be met for alerting, notifying, or warning of LLM 108 (FIG. 1) generated text. The LLM detection threshold can be for percentage of the text passage, which is LLM 108 (FIG. 1) generated, or the LLM detection threshold can be a certain confidence the algorithm has in the determination. In some embodiments of the present invention, the algorithm can include block 418 which can use word processing indicating, e.g., bolding, italicizing, highlights, underlining, striking through, highlighting, changing font color, commenting, etc., to indicate portions of the text passage 204 (FIG. 2) that meet the LLM detection threshold.

To prevent nefarious parties from circumventing the algorithm, each parsed text passage 204 (FIG. 2) can be evaluated alone, and the likelihood of the text passage is scored separately. In other words, if the user attempts to only draft an introduction and conclusion to a text passage 204 (FIG. 2) that is submitted, the algorithm can evaluate the text passage in a manner to avoid being deceived.

In other embodiments of the present invention, the algorithm can include block 416 which can account for user circumvention attempts by considering (weighing) text passage 204 (FIG. 2) submission circumstances such as human error. For example, the LLM 108 (FIG. 1) is much less likely than a human to have incorrect grammar, typographical errors, misuse of words, incorrect punctuation, inconsistent tense, spelling mistakes, etc., which the user can exploit when attempting to circumvent the algorithm. The algorithm can take these human errors into account by evaluating the error location, error frequency, error type, user behavior in previous submissions of the text passage, user behavior in previous submissions of other text passages, etc. Submission circumstances can also include time until a submission is due, time elapsed since submission requested, errors in previous submissions, previous LLM 108 (FIG. 1) text detection evaluations by the algorithm for the user, etc. In an embodiment of the present invention if a confidence level is near the threshold and the time elapsed since the submission is request is relatively short, then the algorithm can consider these additional submission circumstances when predicting whether LLM 108 (FIG. 1) generated text is present.

In some embodiments of the present invention, the submission circumstances can be weighed during all submissions while other embodiments of the present invention may only initiate weighing submission circumstances based on user or third-party direction. In even further embodiments of the present invention, submission circumstances can be initiated when the threshold is met or lower limit than the threshold is met. For example, in instances when the algorithm has a confidence score of 0.65 and the threshold is a confidence score of 0.95, a submission circumstance limit can be a confidence score of 0.50, meaning any confidence score over 0.50 initiates submission circumstance weighing processes.

In even further embodiments of the present invention, the algorithm can include block 420 which can recursively parse the text passage 204 (FIG. 2) if certain portions indicate LLM 108 (FIG. 1) generated text passages or are near indicating LLM 108 (FIG. 1) generated text passages. For example, a threshold of 0.95 confidence score in LLM 108 (FIG. 1) detected text may not be met, but recursive parsing for further detection can initiate at a confidence score of 0.75. The recursive parsing limit can initiate at a lower value than the LLM detection threshold, at the same confidence score as the LLM detection threshold, or a higher confidence score than the LLM detection threshold. This can be useful for users attempting to add user generated text to an otherwise LLM 108 (FIG. 1) generated text passage, or LLM 108 (FIG. 1) text to an otherwise human generated text passage 204 (FIG. 2) and indicating the parsed text passages that are detected to be LLM 108 (FIG. 1) generated. Other forms of AI may be employed to consider these patterns and user behavior in some embodiments of the present invention. These other forms of AI that can be employed can be machine learning techniques like artificial neural networks (ANNs) including recurrent neural networks (RNNs), convolutional neural networks (CNNs), Bayesian neural networks (BNNs), multilayer perceptron (MLP), etc.

The algorithm can also be set to avoid scoring and comparing selected portions of a text passage (FIG. 2) indicated by a user or a third-party. For example, a teacher may require students to have some LLM 108 (FIG. 1) generated text in the text passage 204 (FIG. 2) in an assignment. Certain language or portions (indicated contextually or by location in the text passage) can also be avoided for increased utility of embodiments of the present invention.

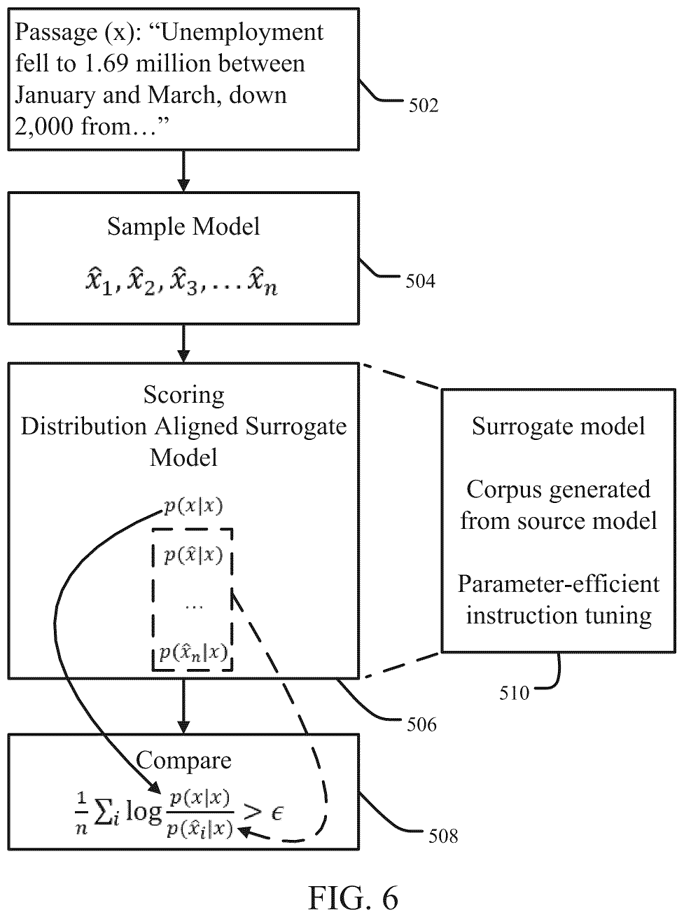

Now referring to FIG. 6, a block diagram with more detail is depicted in accordance with an embodiment of the present invention. An example passage 502 is selected for testing in the framework. The example passage 502 can be informational or can be conversational. Sample model 504 receives the text from example passage 502. Distribution aligned surrogate model 506 scores the probability example passage 502 which is from the given LLM 108 (FIG. 1), by comparing the passage 502 with the information already included in sample model 504. Sample model 504 can be a closed source model. The surrogate model 510 has a corpus of generated text from the source model (e.g., the original LLM) and applies parameter efficient instruction tuning to the surrogate model.

The comparison 508 between the surrogate model 510 and passage 502 can be performed through a variety of methods. In an embodiment, the comparison can be

$$\frac{1}{n} {\sum }_{i} log \frac{p ( x \vert x )}{p ( {\hat{x}}_{i} \vert x )} > ϵ$$

The comparison being the average of the sum of the logarithm of conditional probability p(·|·) and ϵ, a small, positive number used to represent an arbitrarily small quantity or tolerance. The denominator of the logarithm is originally from surrogate model 510 and the numerator being originally from passage 502, where n is the number of samples in surrogate model 510, and i is the given reference the model is compared to. The comparison can scale and normalize the scores. Scaling and normalizing the scores can improve the scores form for representation in score interpretation and analysis.

Given that the sample size of fine-tune data 202 (FIG. 2) can be defined as K₁=Ω(poly(Δ/L)), the probability 1-8, the conditional probability curvature between the surrogate LLM model 206 (FIG. 2) and LLM 108 (FIG. 1) is bounded by |d(X, fₛᵤᵣ)−d(X,fₜₐᵣ)|≤Δ/3, where Ω is a lower bound (e.g. a threshold), poly(Δ/L) is the polynomial of Δ, the margin (or in other words separation parameter), divided by L, the length. d is the conditional probability curvature.

The sample complexity of fine-tuning has a loss L(fₛᵤᵣ, S) of O(1/ϵ²)×O(log(1/δ)). To put this another way, when |S| exceeds

$$O ( 1 / {ϵ}^{2} ) \times O ( log ( \frac{1}{δ} ) ,$$

for almost all X=[P, R] and corresponding l>l(P), the expected value of X is

$${𝔼}_{{X}_{l ∼ {p}_{tar}} ( {X}_{[ : l - 1 ]} )} l ( {X}_{l} \vert {X}_{[ : l - 1 ]} ) \leq ℋ ( {p}_{tar} ( {X}_{[ : l - 1 ]} ) ) + ϵ ,$$

where [symbol] is the entropy, pₜₐᵣ is the probability of the target model, and l is the position in the text. Consequently, the surrogate LLM model 206 (FIG. 2) can approximate the target model after fine-tuning.

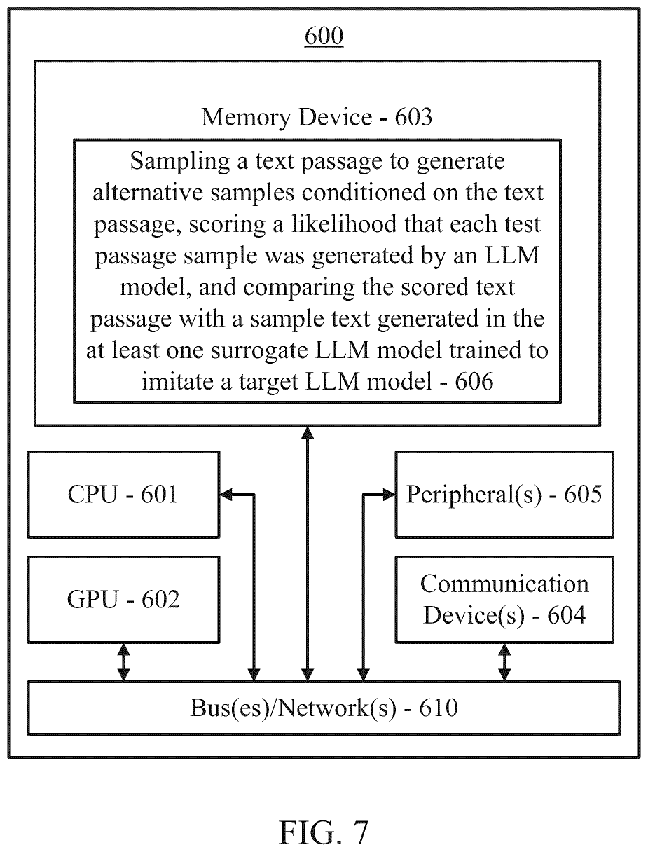

Referring to FIG. 7, a block diagram is shown for an exemplary processing system 600, in accordance with an embodiment of the present invention. The processing system 600 includes a set of processing units (e.g., CPUs) 601, a set of GPUs 602, a set of memory devices 603, a set of communication devices 604, and a set of peripherals 605. The CPUs 601 can be single or multi-core CPUs. The GPUs 602 can be single or multi-core GPUs. The one or more memory devices 603 can include caches, RAMs, ROMs, and other memories (flash, optical, magnetic, etc.). The communication devices 604 can include wireless and/or wired communication devices (e.g., network (e.g., Wi-Fi®, etc.) adapters, etc.). The peripherals 605 can include a display device, a user input device, a printer, an imaging device, and so forth. Elements of processing system 600 are connected by one or more buses or networks (collectively denoted by the figure reference numeral 610).

In an embodiment, memory devices 603 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 603 store program code or software 606 for implementing one or more functions of the systems and methods described herein for sampling a text passage to generate alternative samples conditioned on the text passage, scoring a likelihood that each test passage sample is generated by an LLM model, and comparing the scored text passage with a sample text generated in the at least one surrogate LLM model trained to imitate a target LLM model. The memory devices 603 can store program code for implementing one or more functions of the systems and methods described herein.

Of course, the processing system 600 may also include other elements (not shown), as readily contemplated by one of skill in the art, as well as omitting certain elements. For example, various other input devices and/or output devices can be included in processing system 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 600.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting Large Language Model (LLM) generated text, comprising:
sampling a text passage to generate alternative samples conditioned on the text passage based on a next token prediction in at least one surrogate LLM model;
scoring a likelihood that each test passage sample is generated by an LLM model, the scoring including a conditional probability which quantifies a distribution gap of a log of logits from the at least one surrogate LLM model; and
comparing the scored text passage with a sample text generated in the at least one surrogate LLM model trained to imitate a target LLM model, the comparison including transforming the scores into a scaled representation and normalizing the scores.

2. The method of claim 1, further comprising:
alerting that the text passage has LLM generated text once a LLM detection threshold is met.

3. The method of claim 1, further comprising:
predicting which LLM model generated the text passage.

4. The method of claim 1, further comprising:
weighing submission circumstances with the compared scores.

5. The method of claim 1, further comprising:
parsing the text passage into a predetermined length to increase LLM detection granularity.

6. The method of claim 5, further comprising:
indicating portions of the parsed text passage that are LLM generated once the text passage has met an LLM detection threshold.

7. The method of claim 5, further comprising:
recursively parsing the text passage in response to the text passage reaching a recursive parsing limit to increase LLM detection granularity.

8. A system for detecting Large Language Model (LLM) generated text, comprising:
a processor; and
a memory storing computer-readable instructions that, when executed by the processor, cause the system to:
sample a text passage to generate alternative samples conditioned on the text passage based on a next token prediction in at least one surrogate LLM model;
score a likelihood that each test passage sample is generated by an LLM model, the score includes a conditional probability which quantifies a distribution gap of a log of logits from the at least one surrogate LLM model; and
compare the scored text passage with a sample text generated in the at least one surrogate LLM model trained to imitate a target LLM model, the comparison transforms the scores into a scaled representation and normalizes the scores.

9. The system of claim 8, further causes the system to:
alert that the text passage has LLM generated text once a LLM detection threshold is met.

10. The system of claim 8, further causes the system to:
predict which LLM model generated the text passage.

11. The system of claim 8, further causes the system to:
weigh submission circumstances with the compared scores.

12. The system of claim 8, further causes the system to:
parse the text passage into a predetermined length to increase LLM detection granularity.

13. The system of claim 12, further causes the system to:
indicate portions of the parsed text passage that are LLM generated once the text passage has met an LLM detection threshold.

14. The system of claim 12, further causes the system to:
recursively parse the text passage in response to the text passage reaching a recursive parsing limit to increase LLM detection granularity.

15. A computer program product comprising a non-transitory computer-readable storage medium containing computer program code, the computer program code when executed by one or more processors causes the one or more processors to perform operations, the computer program code comprising instructions to:
sample a text passage to generate alternative samples conditioned on the text passage based on a next token prediction in at least one surrogate LLM model;
score a likelihood that each test passage sample is generated by an LLM model, the score including a conditional probability which quantifies a distribution gap of a log of logits from the at least one surrogate LLM model; and
compare the scored text passage with a sample text generated in the at least one surrogate LLM model trained to imitate a target LLM model, the comparison transforms the scores into a scaled representation and normalizes the scores.

16. The computer program product of claim 15, further causing the processor to:
alert that the text passage has LLM generated text once a LLM detection threshold is met.

17. The computer program product of claim 15, further causing the processor to:
predict which LLM model generated the text passage.

18. The computer program product of claim 15, further causing the processor to:
weigh submission circumstances with the compared scores.

19. The computer program product of claim 15, further causing the processor to:
parse the text passage into a predetermined length to increase LLM detection granularity.

20. The computer program product of claim 19, further causing the processor to:
indicate portions of the parsed text passage that are LLM generated once the text passage has met an LLM detection threshold.
